(19) United States
(12) Patent Application Publication
(10) Pub. No.: US 2016/0217336 A1
(43) Pub. Date: Jul. 28, 2016

(54) TRAFFIC SIGN IDENTIFICATION SYSTEM AND METHOD

(71) Applicant: PAPAGO INC., Taipei City (TW)

(72) Inventors: Shiuan-Yi SU, Taipei City (TW); Liang-Yi CHIEN, Taipei City (TW)

(21) Appl. No.: 14/603,870

(22) Filed: Jan. 23, 2015

(51) Int. Cl. G06K 9/00; G06K 9/52; G06K 9/46

(52) U.S. Cl. CPC G06K 9/00818; G06K 9/4652; G06K 9/52; G06K 9/468; G06K 9/00523

(57) ABSTRACT

A traffic sign identification method using a traffic sign identification system includes: operating a traffic sign image capture unit to capture a road condition image, operating a traffic sign image recognition unit to pick up a traffic sign image from the road condition image, and operating an arithmetic processing unit to convert the original RGB color space of the traffic sign image into a HIS color space, and then to extract one or multiple graphical features from the HIS color space subject to a predetermined graphic pattern, and then to execute a positioning procedure to allocate one traffic sign in the traffic sign image so as to further obtain a digital speed limit image using a matching arithmetic, and then to convert digital speed limit image into a digital speed limit skeleton diagram for identification of the speed limit value of the traffic sign image.

### BACKGROUND OF THE INVENTION

1. Field of the Invention

The present invention relates to traffic sign identification technology and more particularly, to a traffic sign identification system and method that uses a color space conversion technique and image convergence conversion to obtain a skeleton diagram for the identification of a traffic sign.

2. Description of the Related Art

With the progress of the society, cars and buses have become the main transport vehicle of most people. In order to accurately guide the driver to the destination, car navigation technology has been created. Conventional car navigation techniques are commonly of a satellite-based navigation system that uses a satellite receiver to receive signals from multiple satellites for allocating the current location of the car through an algorithm so that related landscape information, speed restriction and other traffic information can be provided to the driver, effectively solving the path-finding problem when the driver is driving the car.

However, conventional car navigation systems can simply guide the driver to drive the car only in accordance with the path planned, and remind the driver of related traffic signs with the information provided in the database. When encountered a speed limit change in an unfamiliar road, the drivers are often unable to respond immediately, resulting in speeding. So, how to be able to pay attention to traffic signs on the route under limitations from the environment and to get complete and effective navigation information is a serious problem to be solved.

### SUMMARY OF THE INVENTION

The present invention has been accomplished under the circumstances in view. It is the main object of the present invention to provide a traffic sign identification system and method, which employs an image recognition technique to obtain any traffic restrictions available at any time on the road, effectively advising the driver to avoid speeding.

To achieve this and other objects of the present invention, a traffic sign identification system in accordance with the present invention comprises a traffic sign image capture unit adapted to capture a road condition image, a traffic sign image recognition unit adapted to pick up a traffic sign image from the road condition image captured by the traffic sign, an arithmetic processing unit adapted to convert the original RGB color space of the traffic sign image into a HIS (Hue-Intensity-Saturation) color space, to extract one or multiple graphical features from the HIS color space subject to a predetermined graphic pattern, to execute a positioning procedure to allocate one traffic sign in the traffic sign image so as to further obtain a digital speed limit image using a matching arithmetic, and to convergence-convert the digital speed limit image into a digital speed limit skeleton diagram for identification of the speed limit value of the traffic sign image.

Preferably, the traffic sign image capture unit is selected from the group of cameras, video cameras, driving recorders and mobile electronic devices having a camera function.

Preferably, the arithmetic processing unit comprises a color conversion module, a feature extraction module, and a skeleton conversion module. The color conversion module is adapted to convert the original RGB color space of the traffic sign image into a HIS (Hue-Intensity-Saturation) color space. The feature extraction module is adapted to extract one or multiple graphical features from the HIS color space subject to a predetermined graphic pattern, and to execute a positioning procedure to allocate one traffic sign in the traffic sign image so as to further obtain a digital speed limit image using a matching arithmetic. The skeleton conversion module is adapted to convergence-convert the digital speed limit image into a digital speed limit skeleton diagram for identification of the speed limit value of the traffic sign image.

To achieve this and other objects of the present invention, a traffic sign identification method in accordance with the present invention comprises the step of: operating a traffic sign image capture unit to capture a road condition image, the step of operating a traffic sign image recognition unit to pick up a traffic sign image from the road condition image captured by the traffic sign, the step of operating an arithmetic processing unit to convert the original RGB color space of the traffic sign image into a HIS (Hue-Intensity-Saturation) color space, the step of extracting one or multiple graphical features from the HIS color space subject to a predetermined graphic pattern and executing a positioning procedure to allocate one traffic sign in the traffic sign image so as to further obtain a digital speed limit image using a matching arithmetic, and the step of convergence-converting the digital speed limit image into a digital speed limit skeleton diagram for identification of the speed limit value of the traffic sign image.

Preferably, the step of operating an arithmetic processing unit to convert the original RGB color space of the traffic sign image into a HIS (Hue-Intensity-Saturation) color space is to operate a color conversion module of the arithmetic processing unit to convert the original RGB color space of the traffic sign image into a HIS (Hue-Intensity-Saturation) color space.

Preferably, the step of extracting one or multiple graphical features from the HIS color space subject to a predetermined graphic pattern and executing a positioning procedure to allocate one traffic sign in the traffic sign image so as to further obtain a digital speed limit image using a matching arithmetic is to operate a feature extraction module for extracting one or multiple graphical features from the HIS color space subject to the predetermined graphic pattern and then to execute a positioning procedure to allocate one traffic sign in the traffic sign image so as to further obtain a digital speed limit image using a matching arithmetic.

Preferably, the step of convergence-converting the digital speed limit image into a digital speed limit skeleton diagram for identification of the speed limit value of the traffic sign image is to operate a skeleton conversion module for convergence-converting the digital speed limit image into a digital speed limit skeleton diagram for identification of the speed limit value of the traffic sign image.

In order to increase the recognition rate without increasing the effectiveness burden, the invention uses a traffic sign image capture unit to capture a part of the road condition image, utilizes the features in the image to determine the speed limit sign to be on the left or right side of the road, and tactically moves the identification range. Thus, the invention can effectively maximize the detection area and improve the recognition rate without changing the range of identification.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a traffic sign identification system in accordance with the present invention.

FIG. 2 is an operational flow of the traffic sign identification system in accordance with the present invention.

FIG. 3A is a schematic drawing illustrating a road condition image captured during the operation of the traffic sign identification system in accordance with the present invention.

FIG. 3B illustrates a circular speed limit sign extracted from the road condition image shown in FIG. 3A.

FIG. 3C illustrates a digital speed limit obtained from the circular speed limit sign shown in FIG. 3B.

FIG. 3D illustrates a digital speed limit skeleton obtained from the digital speed limit shown in FIG. 3C.

### DETAILED DESCRIPTION OF THE INVENTION

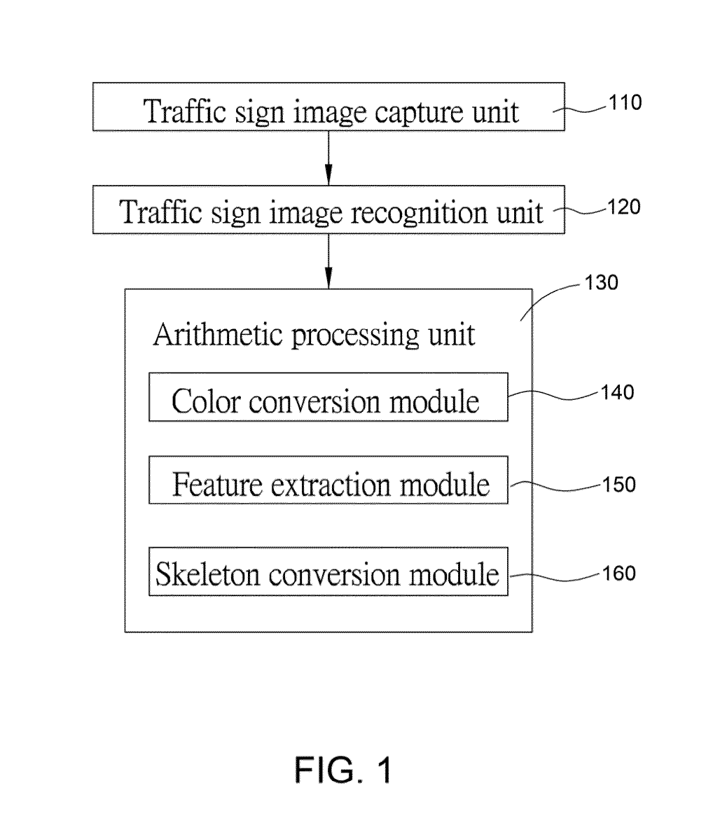

Referring to FIG. 1, a system block diagram of a traffic sign identification system in accordance with the present invention is shown. As illustrated, the traffic sign identification system comprises a traffic sign image capture unit 110, a traffic sign image recognition unit 120, and an arithmetic processing unit 130. The traffic sign image capture unit 110 is adapted to capture a road condition image. The traffic sign image recognition unit 120 is adapted to pick up a traffic sign image from the road condition image.

The arithmetic processing unit 130 comprises a color conversion module 140 adapted for efficient implementation of color space conversion from RGB color space to HIS (Hue-Intensity-Saturation) color space, a feature extraction module 150 adapted to extract one or multiple graphical features from the HIS color space subject to a predetermined graphic pattern, to execute a positioning procedure to allocate one traffic sign in the traffic sign image so as to further obtain a digital speed limit image using a matching arithmetic, and a skeleton conversion module 160 adapted to convergence-convert the digital speed limit image into a digital speed limit skeleton diagram for identification of the speed limit value of the traffic sign image.

In this embodiment, the traffic sign image capture unit can be a camera, video camera, driving recorder, or a mobile electronic device with a camera function.

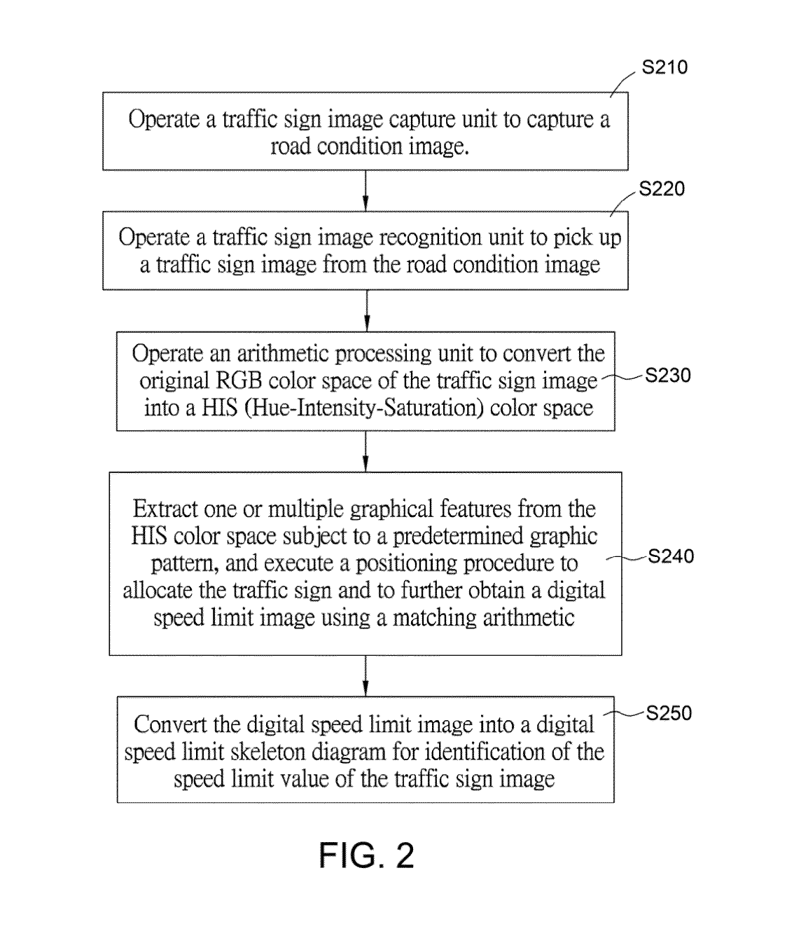

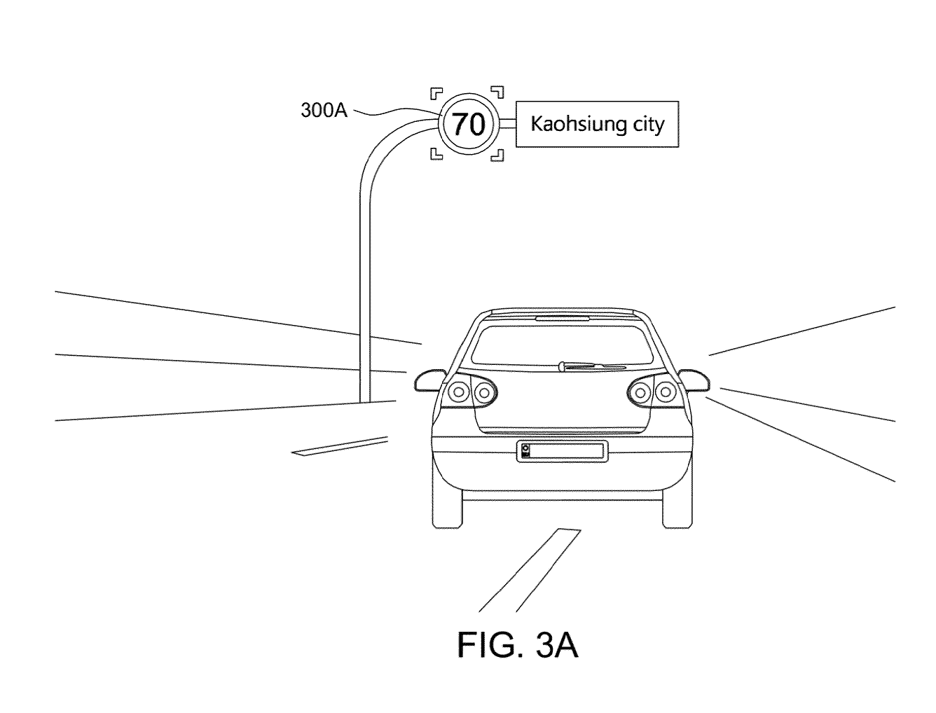

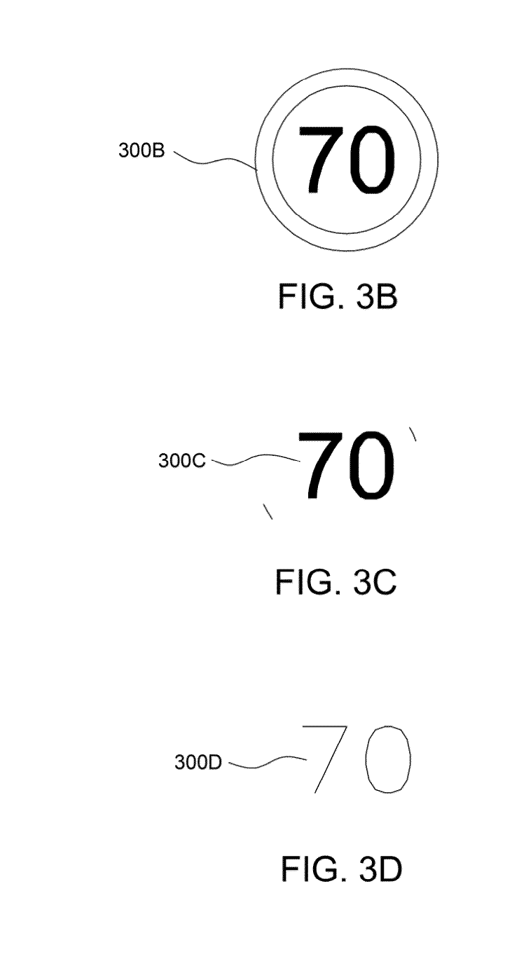

Referring to FIGS. 2 and 3A-3D, a traffic sign identification method in accordance with the present invention comprises the steps of:

S210: Operate a traffic sign image capture unit to obtain a road condition image.

S220: Operate a traffic sign image recognition unit to pick up at least one traffic sign image from the road condition image.

S230: Operate a color conversion module of an arithmetic processing unit to convert the original RGB color space of each traffic sign image into a HIS (Hue-Intensity-Saturation) color space, as shown in FIG. 3A. In this application example, the original RGB color space of the traffic sign image is a color space based on the red color model converted by the color conversion module into a HIS (Hue-Intensity-Saturation) color space of a red color frame-based speed limit sign 300A.

S240: Operate a feature extraction module to extract one or multiple specific graphical features from the HIS (Hue-Intensity-Saturation) color space subject to a predetermined graphic pattern, and to execute a positioning procedure to allocate one traffic sign in the traffic sign image so as to further obtain a digital speed limit image using a matching arithmetic, as shown in FIG. 3B. Regular speed limit signs on the road are circular signs. In this application example, a circular speed limit sign 300B is extracted from the red color frame-based speed limit sign 300A, and then the digital speed limit 300C is obtained from the circular speed limit sign 300B (see FIG. 3C).

S250: Operate a skeleton conversion module to convergence-convert the digital speed limit image into a digital speed limit skeleton diagram for identification of the speed limit value of the traffic sign image, as shown in FIG. 3D. After through the skeleton conversion processing, a digital speed limit skeleton 300D is obtained, and thus the speed limit value is recognized.

The aforesaid skeletonization is to reduce the storage space of the space. All graphics have become a pixel (the width of 1-pixel). Therefore, any intersection of lines can be determined to be a pixel, and then skeleton conversion processing is performed so as to obtain a digital speed limit skeleton 300D.

In conclusion, the use of a circular template of block coding and the introduction of statistical conception in accordance with the present invention enable any circular object in a poor quality image to be matched and allocated. The invention runs a skeletonization algorithm on the content of the traffic sign and applied an object pixel ratio method for the calculation of a particular block, successfully identifying digital computation at a lower volume and improving traffic sign recognition convenience.

Although a particular embodiment of the present invention has been described in detail for purposes of illustration, various modifications and enhancements may be made without departing from the spirit and scope of the invention. Accordingly, the invention is not to be limited except as by the appended claims.

What is claimed is:

1. A traffic sign identification system, comprising:
a traffic sign image capture unit adapted to capture a road condition image;
a traffic sign image recognition unit adapted to pick up a traffic sign image from the road condition image captured by said traffic sign;
an arithmetic processing unit adapted to convert the original RGB color space of said traffic sign image into a HIS (Hue-Intensity-Saturation) color space, to extract one or multiple graphical features from said HIS color space subject to a predetermined graphic pattern, to execute a positioning procedure to allocate one traffic sign in said traffic sign image so as to further obtain a digital speed limit image using a matching arithmetic, and to convert said digital speed limit image into a digital speed limit skeleton diagram for identification of the speed limit value of said traffic sign image.

2. The traffic sign identification system as claimed in claim 1, wherein said traffic sign image capture unit is selected from the group of cameras, video cameras, driving recorders and mobile electronic devices having a camera function.

3. The traffic sign identification system as claimed in claim 1, wherein said arithmetic processing unit further comprises a color conversion module, a feature extraction module, and a skeleton conversion module.

4. The traffic sign identification system as claimed in claim 3, wherein said color conversion module is adapted to convert the original RGB color space of said traffic sign image into a HIS (Hue-Intensity-Saturation) color space.

5. The traffic sign identification system as claimed in claim 3, wherein said feature extraction module is adapted to extract one or multiple graphical features from said HIS color space subject to a predetermined graphic pattern, and to execute a positioning procedure to allocate one traffic sign in said traffic sign image so as to further obtain a digital speed limit image using a matching arithmetic.

6. The traffic sign identification system as claimed in claim 3, wherein said skeleton conversion module is adapted to convert said digital speed limit image into a digital speed limit skeleton diagram for identification of the speed limit value of the traffic sign image.

7. A traffic sign identification method, comprising the steps of:
operating a traffic sign image capture unit to capture a road condition image;
operating a traffic sign image recognition unit to pick up a traffic sign image from the road condition image captured by said traffic sign;
operating an arithmetic processing unit to convert the original RGB color space of said traffic sign image into a HIS (Hue-Intensity-Saturation) color space;
extracting one or multiple graphical features from said HIS color space subject to a predetermined graphic pattern, and executing a positioning procedure to allocate one traffic sign in said traffic sign image so as to further obtain a digital speed limit image using a matching arithmetic; and
converting said digital speed limit image into a digital speed limit skeleton diagram for identification of the speed limit value of said traffic sign image.

8. The traffic sign identification method as claimed in claim 7, wherein the step of operating an arithmetic processing unit to convert the original RGB color space of said traffic sign image into a HIS (Hue-Intensity-Saturation) color space is to operate a color conversion module of said arithmetic processing unit to convert the original RGB color space of said traffic sign image into a HIS (Hue-Intensity-Saturation) color space.

9. The traffic sign identification method as claimed in claim 7, wherein the step of extracting one or multiple graphical features from said HIS color space subject to a predetermined graphic pattern and executing a positioning procedure to allocate one traffic sign in said traffic sign image so as to further obtain a digital speed limit image using a matching arithmetic is to operate a feature extraction module for extracting one or multiple graphical features from said HIS color space subject to said predetermined graphic pattern and then to execute a positioning procedure to allocate one traffic sign in the traffic sign image so as to further obtain a digital speed limit image using a matching arithmetic.

10. The traffic sign identification method as claimed in claim 7, wherein the step of converting said digital speed limit image into a digital speed limit skeleton diagram for identification of the speed limit value of said traffic sign image is to operate a skeleton conversion module for converting said digital speed limit image into a digital speed limit skeleton diagram for identification of the speed limit value of the traffic sign image.
